(19) United States
(12) Patent Application Publication
(10) Pub. No.: US 2015/0128174 A1
(43) Pub. Date: May 7, 2015

(54) SELECTING AUDIO-VIDEO (AV) STREAMS ASSOCIATED WITH AN EVENT

(71) Applicant: Broadcom Corporation, Irvine, CA (US)

(72) Inventors: Robert Americo RANGO, Newport Coast, CA (US); Walter Glenn SOTO, San Clemente, CA (US)

(73) Assignee: Broadcom Corporation, Irvine, CA (US)

(21) Appl. No.: 14/147,454

(22) Filed: Jan. 3, 2014

Related U.S. Application Data
(60) Provisional application No. 61/899,836, filed on Nov. 4, 2013.

(51) Int. Cl. H04N 21/482; H04N 21/81

(52) U.S. Cl. CPC H04N 21/482; H04N 21/8126
USPC 725/34

(57) ABSTRACT

A system for selecting audio-video (AV) streams associated with an event may include a processor and a memory. The processor may be configured to determine when a primary audio-video (AV) stream generated by a primary content producer for an event is being transmitted to a device of a user. The processor may be configured to select alternative AV streams generated by alternative content producers for the event based at least on attributes of the user, characteristics of the alternative content producers, and/or action events occurring within the event. In one or more implementations, the attributes of the user may include associations of the user with one or more of the alternative content producers in a social network. The processor may be configured to provide representations of the selected alternative AV streams to the device for selection by the user in connection with a display of the primary AV stream.

### CROSS-REFERENCE TO RELATED APPLICATIONS

The present application claims the benefit of priority under 35 U.S.C. §119 from U.S. Provisional Patent Application Ser. No. 61/899,836 entitled “Selecting Audio-Video (AV) Streams Associated With An Event,” filed on Nov. 4, 2013, the disclosure of which is hereby incorporated by reference in its entirety for all purposes.

### TECHNICAL FIELD

The present description relates generally to selecting audio-video (AV) streams associated with an event, such as user generated AV streams, and more particularly, but not exclusively, to selecting alternative AV streams associated with an event, such as a live event, based at least on attributes of a viewer viewing a primary AV stream associated with the event.

### BACKGROUND

In traditional television broadcast systems, live events, such as live sporting events, are generally captured using numerous cameras. The owner/provider of the live event, or a production entity associated therewith, selects one of the cameras' video streams to provide to viewers at any given time. The owner/provider may also determine an audio stream to provide with the selected video stream, for example, in the form of audio commentary from announcers selected by the owner/provider. In addition, the owner/provider may determine whether the selected video stream should be augmented with any additional information, such as graphical overlays. Thus, in traditional broadcasting systems, viewers of a live event may only have the option of viewing/hearing an audio-video (AV) stream that is produced by the owner/provider of the live event.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in which a system for selecting audio-video (AV) streams associated with an event may be implemented in accordance with one or more implementations.

FIG. 2 illustrates an example component data flow schematic for selecting AV streams associated with an event in accordance with one or more implementations.

FIG. 3 illustrates an example user interface for presenting representations of selected AV streams associated with an event in accordance with one or more implementations.

FIG. 4 illustrates a flow diagram of an example process for selecting AV streams associated with an event in accordance with one or more implementations.

FIG. 5 conceptually illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology.

In traditional television broadcast systems, the audio and/or video streams provided to viewers for a television broadcast of a live event (e.g., a live sporting event) may not be of interest to all of the viewers. For example, during a television broadcast of a football game, some viewers may not be interested in the camera angle associated with the video stream provided for the broadcast, and/or some viewers may not be interested in the audio commentary and/or an announcer associated with the audio stream provided for the broadcast. For some live events, alternative audio and/or video streams for the live event may be available via other channels; for example, an alternative audio commentary may be available via a different television channel and/or via a radio channel. Thus, a viewer may switch between different television and/or radio channels to obtain the audio and/or video streams for the live event that are most aligned with the viewer's interests. However, it may be time-consuming and tedious for the viewer to search through television and/or radio channels to find available alternative audio and/or video streams for the live event, and/or to search through the available alternative audio and/or video streams to determine the audio and/or video streams most aligned with the viewer's interests. Furthermore, some viewers may be unable to find any audio and/or video streams for the live event that are aligned with their interests.

Live streaming technologies may allow an owner/provider of a live event to provide viewers with multiple different audio/video (AV) streams for the live event. For example, the owner/provider may authorize multiple individual users to generate AV streams for the live event, which may be referred to as alternative AV streams for the live event (as opposed to the primary AV stream produced by the owner/provider of the live event). The individual authorized users may be able to select video streams from any of the available cameras for the live event (not just the video stream of the camera selected by the owner/provider of the live event). The users may also be able to provide their own audio streams, for example, audio commentaries, that supplement, or replace, the audio stream provided by the owner/provider of the live event. The users may further supplement a selected video stream with supplemental video content, such as an overlay and/or a supplemental video stream. A viewer of the primary AV stream for the live event, such as the television broadcast for the live event, may be able to switch from the primary AV stream to one of the alternative AV streams generated for the live event. However, some of the alternative AV streams generated for the live event may not be of interest to the viewer and it may be tedious and time-consuming for the viewer to search through available alternative AV streams for the live event, particularly when a large number of alternative AV streams are generated for the live event.

The subject system dynamically selects alternative AV streams generated for a live event that may be of interest to a viewer based at least on attributes of the viewer. The subject system transmits representations of the selected alternative AV streams to a device of the viewer for selection by the viewer, for example, while the viewer is viewing a primary AV stream for the live event. In one or more implementations, the subject system may select alternative AV streams that may be of interest to the viewer by correlating metadata associated with the viewer, such as metadata indicative of the viewer's viewing/listening preferences/history, with metadata associated with the users generating the alternative AV streams. In one or more implementations, the subject system may interface with a social networking system to retrieve/generate metadata associated with the viewer and/or metadata associated with the users generating the alternative AV streams. For example, the subject system may retrieve metadata from the social networking system that is indicative of associations, or relationships, between the viewer and one or more of the users generating the select alternative AV streams.

In one or more implementations, the subject system may select alternative AV streams by further correlating the metadata associated with the viewer, and/or the metadata associated with the users generating the alternative AV streams, with metadata associated with action events occurring during the live event, such as plays of a football game. For example, if a passing play occurs during a football game, the subject system may identify a user generating an alternative AV stream who is associated with metadata related to passing plays, such as metadata that indicates that the user is a former quarterback. Thus, the subject system selects alternative AV streams for a live event that may be of interest to a viewer based at least on metadata associated with the viewer, metadata associated with the users generating the alternative AV streams, and/or metadata indicative of action events occurring during the live event. Accordingly, the subject system allows a viewer of a primary AV stream for a live event to quickly identify, and switch to, alternative AV streams for the live event that are of interest to the viewer.

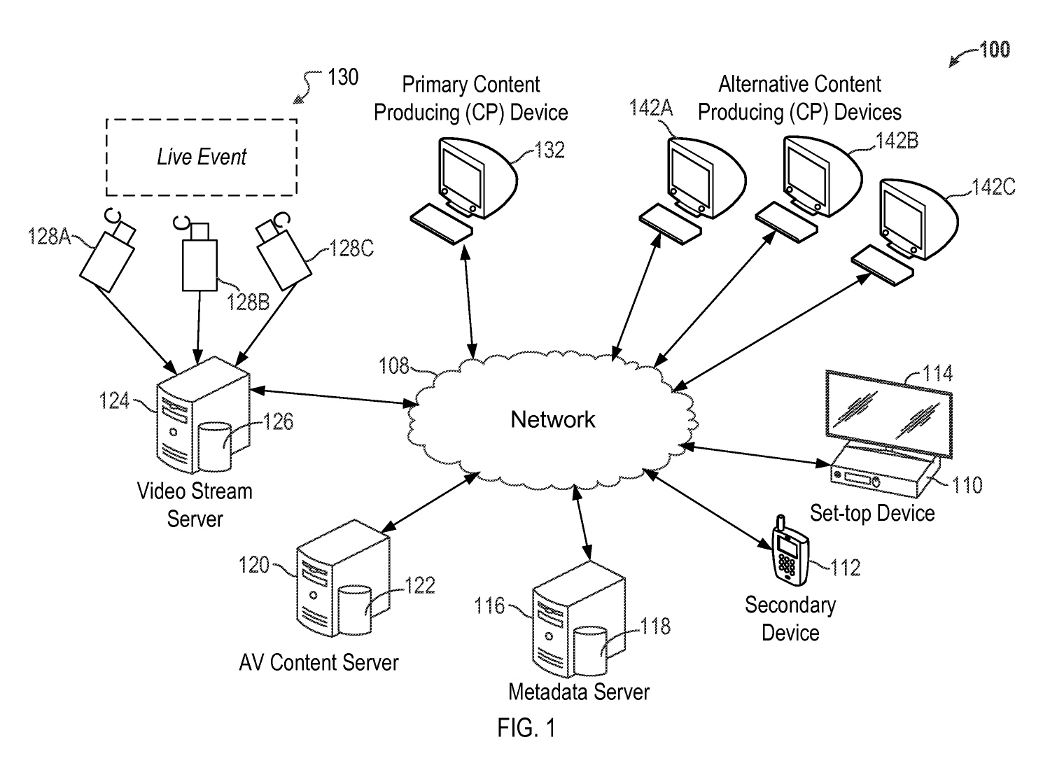

FIG. 1 illustrates an example network environment 100 in which a system for selecting AV streams associated an event may be implemented in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

Example network environment 100 includes network 108, metadata server 116 and associated data store 118, audio-video (AV) content server 120 and associated data store 122, video stream server 124 and associated data store 126, video cameras 128A-C that may record live event 130, primary content producing (CP) device 132, alternative content producing (CP) devices 142A-C, set-top device 110, output device 114, and secondary device 112.

Network 108 may be, and/or may include, a public communication network (such as the Internet, cellular data network, dialup modems over a telephone network) and/or a private communications network (such as private local area network (“LAN”), leased lines). For example, network 108 may include a private LAN that couples primary CP device 132 to video stream server 124 and a public communication network that couples alternative CP devices 142A-C to video stream server 124. Network 108 may include one or more content distribution networks and/or content distribution channels, for example, for distributing AV streams produced by primary CP device 132 and/or alternative content producers 142A-C to set-top device 110 and/or secondary device 112. Network 108 may include wired transmission networks, for example, fiber-optic transmission networks, coaxial transmission networks, etc. and/or wireless transmission networks, for example, satellite transmission networks, over-the-air antenna transmission networks, etc.

Set-top device 110 may be referred to as a set-top box and may be a device that is coupled to, and is capable of presenting AV streams to a user on, output device 114, such as a television, a monitor, speakers, or any device capable of presenting AV streams to a user. In one or more implementations, set-top device 110 may be integrated within output device 114. Set-top device 110 may be any appliance device that receives an external source signal, and converts the source signal into a form that can be displayed on a display device, including, for example, a laptop or desktop computer, smartphone, tablet device, or other display with one or more processors coupled thereto and/or embedded therein. Secondary device 112 may be a device associated with a user viewing AV streams presented by set-top device 110 on output device 114. In one or more implementations, secondary device 112 may be referred to as a second-screen device and may generally be located proximal to set-top device 110 and/or output device 114, for example, when the user is viewing AV streams presented by set-top device 110 on output device 114. Secondary device 112 can be one or more computing devices, such as laptop or desktop computers, smartphones, tablet devices, or other displays with one or more processors coupled thereto and/or embedded therein. In the example of FIG. 1, secondary device 112 is depicted as a smart phone. In one or more implementations, set-top device 110 and/or secondary device 112 may be referred to as a user device or a client device.

Servers 116, 120, 124, may each be individual computing devices such as computer servers, and/or may all be a single computing device. In one or more implementations, servers 116, 120, 124 may represent one or more computing devices (such as a cloud of computers and/or a distributed system) that are communicatively coupled, such as communicatively coupled over network 108, that collectively, or individually, perform one or more functions that can be performed server-side. Servers 116, 120, 124 may each be coupled with various databases, storage services, or other computing devices, such as data stores 118, 122, 126, respectively. Data stores 118, 122, 126 may each include one or more storage devices, such as hard drives. In some aspects, the functionality of servers 116, 120, 124 may be implemented on the same physical server or distributed among multiple servers. Similarly, the functionality of data stores 118, 122, 126 may be implemented in the same storage device or database, or distributed across multiple storage devices or databases. When data stores 118, 122, 126 are implemented as databases, the databases may take any form such as relational databases, object-oriented databases, file structures, text-based records, or other forms of data repositories.

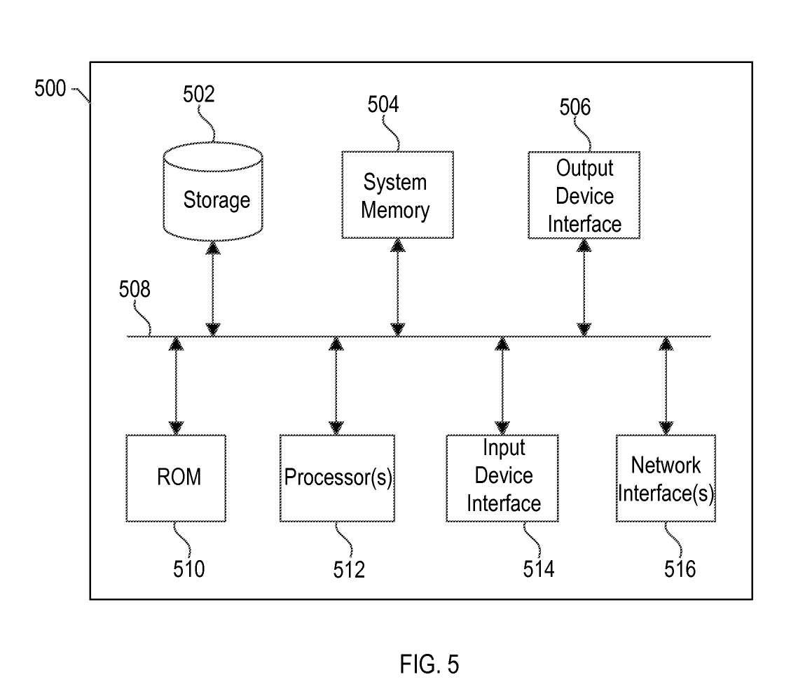

Primary CP device 132 and alternative CP devices 142A-C may each be, or may each include, one more computing devices that are configured to produce an AV stream from a video stream, such as a video stream generated by one of video cameras 128A-C, one or more audio streams, such as audio streams that include audio commentary, and/or additional content, such as overlays, additional video content, etc. Video cameras 128A-C may be any recording device that can generate video streams, such as native MPEG (Moving Picture Experts Group) transport streams, or video streams that may be converted to an MPEG transport stream. Set-top device 110, output device 114, secondary device 112, servers 116, 120, 124, cameras 128A-C, primary CP device 132, and/or alternative CP devices 142A-C may be, or may include, one or more components of the electronic system discussed below with respect to FIG. 5.

When live event 130 is occurring, video cameras 128A-C may generate different video streams from live event 130, which may be referred to as camera video streams for live event 130. For example, video cameras 128A-C may be positioned at different angles relative to live event 130 and/or may be located at different locations relative to live event 130. In this regard, live event 130 may be any live event, such as a sporting event, a music event, a television show recorded live, such as a game show, etc. Live event 130 may occur at a geographic location, and video cameras 128A-C may be located at, or proximal to, the geographic location. Video cameras 128A-C may be communicably coupled to video stream server 124. Video stream server 124 may receive one or more camera video streams from video cameras 128A-C, may store the camera video streams, for example, in data store 126 and/or may provide the camera video streams, for example, to primary CP device 132 and/or alternative CP devices 142A-C. In one or more implementations, the camera video streams generated by different video cameras 128A-C may be selected in real-time by primary CP device 132 (e.g., by an operator using the device) and/or alternative CP devices 142A-C for live broadcast of live event 130 to one or more devices, including set-top device 110 or secondary device 112.

In one or more implementations, video cameras 128A-C may be synchronized using common reference clock timestamps inserted into or embedded within the camera video streams, and correlated to a common time base, such as a starting time of live event 130. For example, common reference clock timestamps may be a Society of Motion Pictures and Television Engineers (SMPTE) time code, or a presentation timestamp (PTS) or program clock reference (PCR). In one or more implementations, the common reference clock timestamps may be inserted as fields in transport stream packet headers of the camera video streams and/or as time marker packets that are inserted into the camera video streams. For example, video stream server 124 may synchronize video cameras 128A-C based on a common reference clock that has a time base corresponding to the start of live event 130. In one or more implementations, video cameras 128A-C may also insert video camera identifiers into the generated camera video streams. The camera identifiers may be, for example, a field inserted into transport stream packet headers and/or as inserted video camera identifier packets.

In one or more implementations, video stream server 124 may maintain the common reference clock for the camera video streams. Accordingly, video stream server 124 may receive the camera video streams from video cameras 128A-C and may insert common reference clock timestamps based on the common reference clock into the camera video streams, for example, as fields inserted into transport stream packet headers and/or by inserting common timestamp packets into the camera video streams. Since the transmission latency between video cameras 128A-C and video stream server 124 may be minimal and/or generally equivalent across video cameras 128A-C, video stream server 124 may be able to uniformly insert common reference clock timestamps into the camera video streams. Video stream server 124 may also insert video camera identifiers into the camera video streams generated by video cameras 128A-C, for example, as a field inserted into transport stream packet headers and/or as inserted video camera identifier packets.

In one or more implementations, the camera video streams that are generated by video cameras 128A-C, and that include inserted timestamps and/or identifiers, may be broadcast to one or more devices as streaming media and/or stored by video stream server 124, such as in data store 126. In one or more implementations, the camera video streams may be transmitted to AV content server 120 and the camera video streams may be stored, including any inserted timestamps and/or identifiers, by AV content server 120, for example, in data store 122. In one or more implementations, the camera video streams may be stored with an identifier of live event 130 and an identifier of one of video cameras 128A-C, such as video camera 128A that generated the camera video stream.

Primary CP device 132 may be associated with an owner/provider of live event 130, such as a football league for a football game, and/or a production entity associated therewith. When a live event 130 is occurring, primary CP device 132 may select one or more of the camera video streams from video stream server 124 and may produce an AV stream that includes the selected camera video stream(s), an audio stream, such as audio commentary by one or more announcers selected by the owner/provider of live event 130, and/or additional content, such as an overlay. The AV stream generated by primary CP device 132 for live event 130 may be referred to as a primary AV stream for live event 130.

Primary CP device 132 may select the camera video stream that the owner/provider of live event 130 believes will be of most interest to viewers, such as a camera video stream generated by video camera 128A with a particular angle for viewing an action event of live event 130, such as a play of a football game. Primary CP device 132 may change camera video streams as frequently, or as often, as is desirable to the owner/entity of live event 130. Thus, the primary AV stream generated by primary CP device 132 may include concatenated camera video streams generated by multiple different video cameras 128A-C. However, the primary AV stream may still include the common reference clock timestamps and/or video camera identifiers previously inserted into the individual camera video streams, for example, by video cameras 128A-C and/or video stream server 124. In one or more implementations, primary CP device 132 may insert video camera identifiers associated with the camera video stream currently selected by primary CP device 132 into the primary AV stream, for example, as fields inserted into the transport stream packet headers.

The primary AV stream generated by primary CP device 132 may be provided for transmission to set-top device 110 and/or secondary device 112, via one or more content distribution channels of network 108. For example, the primary AV stream may be provided to set-top device 110 via a television channel of a television network. In one or more implementations, the primary AV stream may also be transmitted to AV content server 120, and the primary AV stream may be stored, including any inserted timestamps and/or identifiers, by AV content server 120, such as in data store 122. In one or more implementations, the primary AV stream may be stored with an AV stream identifier, an event identifier, an identifier of primary CP device 132, and/or an identifier of an entity associated therewith, such as the owner/provider of live event 130.

Alternative CP devices 142A-C may be associated with one or more individuals authorized by the owner/entity of live event 130 to generate, or produce, an AV stream for live event 130. These authorized individuals may be, for example, former or current players of a sport corresponding to live event 130, former or current officials or referees for a sport corresponding to live event 130, persons of pop culture significance, political figures, or generally any authorized individuals who may generally offer a different perspective of live event 130 than the perspective conveyed by the primary AV stream generated by primary CP device 132. In one or more implementations, the authorized individuals for live event 130 may be referred to as alternative content producers for live event 130.

When live event 130 is occurring, alternative CP devices 142A-C may each produce an AV stream that includes a selected camera video stream together with an audio stream, such as audio commentary by the alternative content producer, and/or additional content, such as an overlay, additional video content, etc. In one or more implementations, the AV streams generated by alternative CP devices 142A-C for live event 130 may be referred to as alternative AV streams generated for live event 130. For example, alternative CP devices 142A-C may select one of the camera video streams generated by cameras 128A-C, such as a camera video stream corresponding to an angle or position of one of cameras 128A-C that is most interesting to the alternative content producers. In one or more implementations, at any given time the camera video stream selected by one or more of alternative CP devices 142A-C may not coincide with the camera video stream selected by primary CP device 132 for the same time period during live event 130, and/or may not coincide with other alternative CP devices 142A-C. Thus, at any given time during live event 130 the camera video stream included in the primary AV stream generated by primary CP device 132 may be different from the camera video stream included in the alternative AV stream generated by one or more of alternative CP devices 142A-C.

Alternative CP devices 142A-C may change camera video streams as frequently, or as often, as is desirable to the content producers. Thus, the camera video streams of alternative AV streams generated by alternative CP devices 142A-C may include concatenated camera video streams generated by multiple different video cameras 128A-C. However, the alternative AV streams may include any common reference clock timestamps and/or video camera identifiers previously inserted into the individual camera video streams, for example, by video cameras 128A-C and/or video stream server 124 so that content provided in a respective alternative AV stream may be synchronized with content provided in the individual camera video streams. In one or more implementations, alternative CP devices 142A-C may insert video camera identifiers associated with the camera video stream selected by alternative CP devices 142A-C into the alternative AV streams, for example, as fields inserted into the transport stream packet headers.

The alternative AV streams generated by alternative CP devices 142A-C may be provided for transmission to set-top device 110 and/or secondary device 112 via one or more content distribution channels of network 108, for example, when requested by set-top device 110 and/or secondary device 112. In one or more implementations, when the primary AV stream generated by primary CP device 132 for live event 130 is being presented to a user via set-top device 110, set-top device 110 and/or secondary device 112 may provide the user with an option to view one or more of the alternative AV streams generated by alternative CP devices 142A-C for live event 130. In one or more implementations, the alternative AV streams may be identified automatically by AV content server 120 or by metadata server 116 based on metadata provided by, for example, set top device 110, secondary device 112, primary CP device 132, or one or more of alternative CP devices 142A-C.

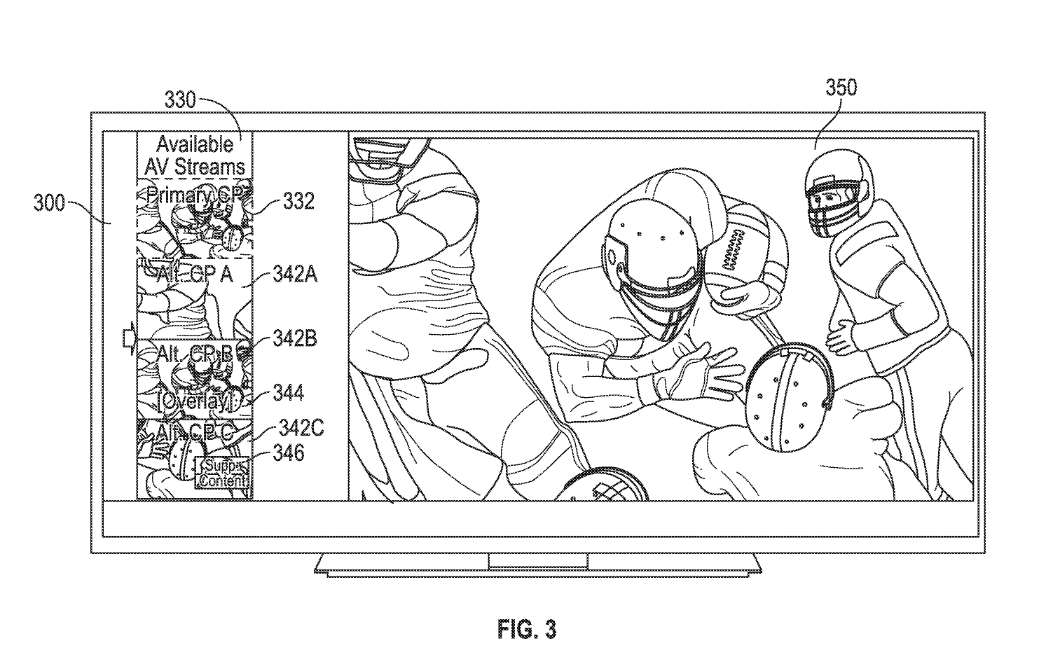

For example, metadata server 116 may search data store 118 for metadata items received for live event 130 to identify one or more alternative CP devices 142A-C that are producing alternative AV streams for live event 130. Metadata server 116 may select one or more of the identified alternative AV streams based at least on attributes of the user associated with set-top device 110 and/or secondary device 112, and may provide representations of the selected available alternative AV streams to set-top device 110 and/or secondary device 112. The user then may interact with set-top device 110 and/or secondary device 112 to select one of the available alternative AV streams. The alternative AV stream selected by the user may then be provided to set-top device 110 and/or secondary device 112, for example, in place of and/or in combination with, the primary AV stream for live event 130. An example user interface for providing representations of available AV streams for selection by a user, is discussed further below with respect to FIG. 3.

The AV streams generated by alternative CP devices 142A-C may also be transmitted to AV content server 120, and may be stored, including any inserted timestamps and/or identifiers and/or any metadata embedded therein, by AV content server 120, such as in data store 122. In one or more implementations, the AV streams may be stored with an AV stream identifier, for example, a unique identifier generated for each AV stream, an event identifier of live event 130, an identifier of a corresponding alternative CP device 142A that produced the AV stream, and/or an identifier of the content producer associated therewith.

During live event 130, primary content producer metadata may be provided to metadata server 116 (e.g., in real-time or near real-time) in connection with a primary AV stream for live event 130. The primary content producer metadata may include, for example, one or more metadata items, each including one or more fields containing data about live event 130, or the primary AV stream associated with live event 130. A metadata item may be associated with a certain point-in-time within live event 130 by including (e.g., in a field of the metadata item) an event identifier of live event 130 and a timing indicator that is indicative of a point-in-time during live event 130, for example, relative to the common reference clock. A metadata item further may describe certain action events occurring at one or more points-in-time within live event 130. For example, in a football game, an action event may be a particular play in the game. In this example, the metadata item corresponding to the play may include a timing indicator that is indicative of a point-in-time corresponding to the play during the live event 130, and some action event information that is indicative of the play at the point-in-time indicated by the metadata item.

In one or more implementations, when an action event occurs during live event 130, primary CP device 132 may generate a metadata item for the action event. The metadata item may include an action event tag and a timing indicator corresponding to when, during live event 130, the action event occurred. In some implementations, an event identifier for live event 130 in which the action event took place may also be included, for example, to allow for storage of the metadata item together with other metadata apart from storage of live event 130. Metadata items may be generated during live event 130 or after live event 130 is complete, for example, to provide metadata for stored AV streams. The owner/provider of live event 130, or an entity associated therewith, may also generate metadata items that relate to action events occurring during live event 130.

In one or more implementations, when a respective action event occurs during live event 130, one or more metadata items, including an action event tag and/or other information about the action event, may be sent by primary CP device 132 to metadata server 116 contemporaneously (or near contemporaneously) with the primary AV stream being provided to set-top device 110 for live event 130. In one or more implementations, the metadata transmitted by primary CP device 132 may be referred to as primary content producer metadata. Similarly, alternative content producer metadata may be transmitted by the alternative CP devices 142A-C contemporaneous with the transmission of alternative AV streams. The alternative content producer metadata for the alternative AV streams may be generated, for example, by one or more alternative CP devices 142A-C when generating or transmitting the alternative AV streams. Metadata server 116 may correlate the primary content producer metadata provided in connection with the primary AV stream with alternative content producer metadata provided in connection with alternative AV streams to identify available alternative AV streams associated with live event 130 and/or an action event at a certain point-in-time.

Metadata server 116 may then further filter the available alternative AV streams for each user viewing live event 130 based at least on user metadata associated with each user. For example, a user viewing one of the AV streams associated with live event 130 via set-top device 110 may perform one or more actions that may be indicative of a preference of the user. The actions may include marking a point-in-time during live event 130 that is of interest to the user, replaying an action event during live event 130, changing to another channel and/or AV stream during live event 130, or generally any other action that may be indicative of a preference of the user. The actions may be performed by the user via set-top device 110 and/or secondary device 112. For example, the user may designate a marked point-in-time in real-time during a television broadcast of live event 130. Set-top device 110 and/or secondary device 112 may generate a user metadata item corresponding to the action performed by the user. For example, a user metadata item for a marked point-in-time may include an identifier of live event 130, an identifier of the user, a timing indicator, and/or an identifier for the AV stream being viewed by the user.

Accordingly, user metadata items that are indicative of preferences and/or interests of a user may be generated over time for the user, for example, based at least on the user's interactions with set-top device 110 and/or secondary device 112. In one or more implementations, the user metadata items may further include, for example, information collected when a user expressed interest in an action event that occurred during live event 130 (or a similar action event), which may be referred to as an action event tag. A user may generate an action event tag, for example, by selecting an alternative AV stream during live event 130 or by marking a point-in-time during live event 130. Information within a user metadata item may include or be derived from event-related information provided by a user profile or social activity within, for example, a social network. In one or more implementations, metadata server 116 may interface with a social networking system to retrieve and/or generate user metadata items for a user. The user metadata items may be indicative of associations of the user in the social networking system, such as with one or more of the alternative content producers.

In one or more implementations, metadata server 116 may receive a user metadata item and associate the user metadata item with other metadata items for an action event during live event 130 and/or with points-in-time marked during live event 130. In this manner, metadata server 116 may determine which alternative AV streams may be related to the user metadata item, or action event tag within the user metadata item, and thus determine what available alternative AV streams or portions thereof are of interest to the user. For example, metadata server 116 may first correlate primary content producer metadata received (e.g., in connection with live event 130) from primary CP device 132 with alternative content producer metadata received from alternative CP devices 142A-C to identify a pool of alternative AV streams. Metadata server 116 may then further refine the available alternative AV streams for each operably connected set-top device 110 based on user metadata received from the set-top device 110. Metadata items, or information therein, received from various sources may be associated by, for example, comparing timing information to identify metadata items that are temporally related to a point-in-time during live event 130, comparing action event tag information and/or timing information to identify metadata items corresponding to the same action event tag, or comparing camera identifier information to identify AV streams having a particular view of interest to the user.

In one or more implementations, metadata server 116 may be operably connected to one or more applications running on secondary device 112 of the user, such as social networking applications, messaging applications, etc., to allow the user to generate metadata items at marked points-in-time or for certain action events via these applications. For example, secondary device 112 may include an application installed thereon which is configured to operate in coordination with live event 130 (e.g., as an AV stream corresponding to live event 130 is displayed on set-top device 110) and configured to receive marked points-in-time from a user via an interactive user interface.

The user interface may further be configured to display, for user selection, indications of action events contained within metadata items received by metadata server 116, including primary content producer metadata sent in connection with the primary AV stream and alternative content producer metadata sent in connection with available alternative AV streams. On selection of a displayed indication of an action event within live event 130, user metadata item may be generated which includes a corresponding action event tag and timing information for when the action event occurred within live event 130.

In one or more implementations, metadata server 116 may be operably connected to a server (e.g., server 116, 120, or 124) that hosts a social networking system that is accessible to the user via, for example, set-top device 110 or secondary device 112. For example, the social networking system may provide an application programming interface (API) which facilitates metadata server 116 in retrieving user metadata information from user profiles or from user activity streams of the social networking system. In one or more implementations, the social networking system may access an API provided by metadata server 116 to provide user metadata to metadata server 116 when appropriate. For example, a user may generate a message via the social networking system that includes an identifier from which live event 130 can be determined, for example, a hash tag corresponding to live event 130. Thus, metadata server 116 may monitor the social networking system to determine when such a message has been generated by the user. Metadata server 116 may then generate a user metadata item corresponding to the identifier in the message.

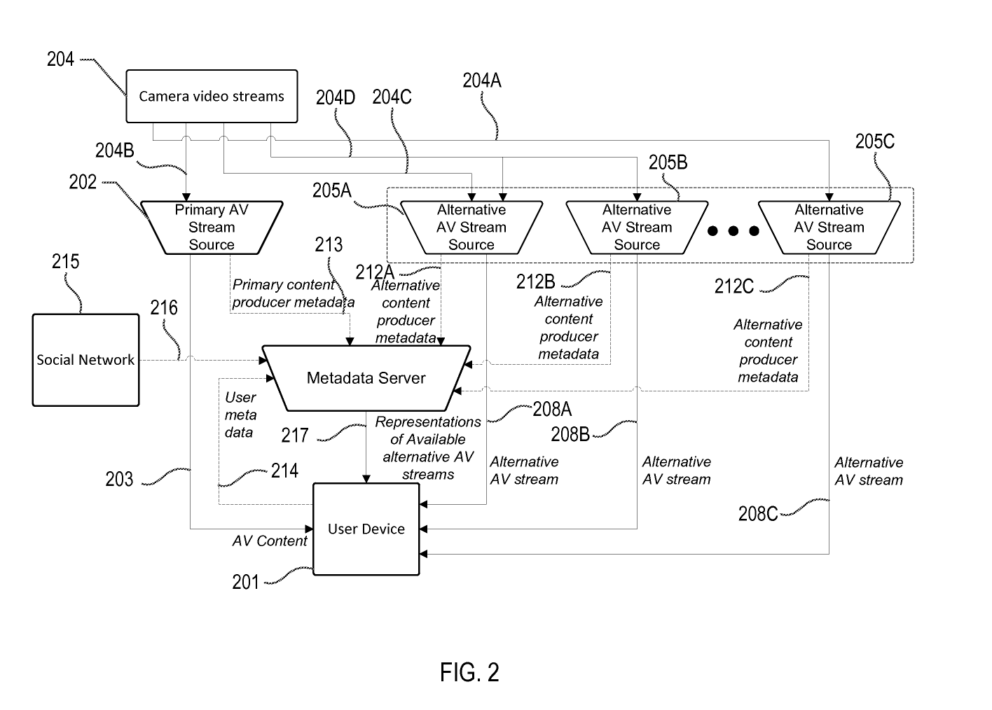

FIG. 2 illustrates an example component data flow schematic for selecting AV streams associated with an event in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

In the depicted example, user device 201 is operably connected to metadata server 116 and primary AV stream source 202. User device 201 may be any device capable of receiving and/or displaying AV content for presentation of the AV content to one or more users, including, for example, set-top device 110, output device 114, or secondary device 112. Primary AV stream source 202 includes a source of primary AV stream 203. As previously discussed, primary CP device 132 is used to generate primary AV stream 203 from one or more camera video streams 204 generated by video cameras 128A-C, such as camera video stream 204B. In this regard, primary AV stream source 202 may be representative of video stream server 124, AV content server 120, primary CP device 132, a primary content producer operating primary CP device 132, and/or any combination thereof. Once generated, primary AV stream 203 is provided to user device 201, for example, via previously described network 108.

Alternative AV stream sources 205A-C are representative of sources for alternative AV streams produced by alternative CP devices 142A-C. Each alternative AV stream may be produced from one or more of the provided camera video streams 204 for live event 130, for example, by video cameras 128A-C. In this regard, each of alternative AV stream sources 205A-C may be representative of one of alternative CP devices 142A-C and/or an alternative content producers operating one of alternative CP devices 142A-C. In the depicted example, alternative AV stream source 205A receives camera video streams 204C-D from available camera video streams 204 and produces alternative AV stream 208A, alternative AV stream source 205B receives camera video stream 204D and produces alternative AV stream 208B, and alternative AV stream source 205C receives camera video stream 204A and produces alternative AV stream 208C. Alternative AV streams 208A-C produced by alternative AV stream sources 205A-C may be stored (e.g., by AV content server 120) or made available for transmission, for example, over network 108 to operably connected devices.

Alternative AV stream sources 205A-C are operably connected to metadata server 116 in a manner that allows metadata server 116 to receive alternative content producer metadata 212A-C from alternative AV stream sources 205A-C. In one or more implementations, each of alternative AV stream sources 205A-C may access an API, such as a web-enabled API, provided by metadata server 116 for registering available alternative AV streams. For example, alternative AV stream source 205A may register by providing metadata server 116 with a source identifier for alternative AV stream source 205A, an event identifier corresponding to live event 130 for which alternative AV streams are to be made available, and/or an alternative AV stream identifier for each alternative AV stream to be made available by alternative AV stream source 205A for live event 130. Alternative AV stream source 205A may also provide metadata server 116 with alternative content producer metadata that includes or describes one or more characteristics of the alternative content producer, such as the authorized individual. In this manner, metadata server 116 may be made aware of a pool of available alternative AV streams 208A-C for live event 130, along with characteristics of the alternative content producers generating alternative AV streams 208A-C.

Metadata server 116 receives primary content producer metadata 213 provided in connection with primary AV stream 203 for live event 130 and identifies available alternative AV streams 208A-C for live event 130. Primary content producer metadata 213 includes, for example, one or more metadata items that contain information about action events occurring within live event 130. A metadata item may include, for example, action event tags corresponding to action events occurring in live event 130. In one or more implementations, to identify available alternative AV streams 208A-C, metadata server 116 may correlate primary content producer metadata 213 as it is received with alternative content producer metadata 212A-C received from alternative AV stream sources 205A-C. For example, metadata server 116 may perform a search of registered alternative AV stream sources 205A-C based on an identifier for live event 130 or primary AV stream 203 to identify alternative AV streams 208A-C corresponding to live event 130 or primary AV stream 203.

Once one or more alternative AV streams 208A-C are identified, metadata server 116 may filter available alternative AV streams 208A-C by appending the search with information retrieved received from, for example, user metadata 214. For example, metadata server 116 may receive user metadata 214 including a “touchdown” action event tag, and then may search for available alternative AV streams 208A-C that include a tag for a “touchdown” at or near a time code location corresponding to the time at which the action event tag was received by metadata server 116 or a time at which the metadata item was generated, for example, at user device 201.

Similarly, metadata server 116 may receive user metadata 214 that includes one or more attributes or preferences of a user and metadata server 116 may search for available alternative AV streams 208A-C that are being generated by alternative content producers that have characteristics that coincide with the preferences of the user, for example as indicated by alternative content producer metadata 212A-C. For example, user metadata 214 may indicate that the user prefers a particular type of audio commentary, such as funny, intellectual, in a particular language, etc., and alternative content producer metadata 212A-C may indicate the type of audio commentary provided by the alternative content producers, such as funny, intellectual, in a particular language, etc. In one or more implementations, the user may opt-in, or otherwise control, user metadata 214 provided to, or obtained by, metadata server 116.

In one or more implementations, alternative AV streams 208A-C may be identified in real-time. User metadata 214 may include action event tags and other metadata information for live events 130 generated by a user activating a control at user device 201, or from, for example, one or more user profiles. For example, users who are authenticated to metadata server 116 may provide profiles that describe their interests, commentary styles, and the like. Additionally or in the alternative, a profile may be generated based on a user's social networking profile. A user profile may be matched to an alternative content producer profile for alternative AV stream 208A by matching information in the user profile with a profile associated with the alternative content producer, for example as indicated by the alternative content producer metadata 212A. For example, an alternative content producer profile may indicate that the alternative content producer generating alternative AV stream 208A may be a former quarterback. If the user profile indicates that the user has a history of watching quarterbacks make passing plays then metadata server 116 may match the user profile of the user with the profile of the alternative content producer generating alternative AV stream 208A.

A user profile may also be matched to the profiles of other users. For example, a first user may have a viewing history of watching AV streams generated by quarterbacks, and a second user's profile may indicate that the second user is a quarterback. Similarly the first user may have a viewing history of watching AV streams generated by individuals having “X” characteristic (happy, sad, angry, intelligent, funny, etc.), and the characteristic may be matched to the second user's profile. If an alternative AV stream is identified for the second user, or the second user is or associated with the alternative AV stream, then the alternative AV stream may be identified by metadata server 116 for selection by the first user, since the first user may have similar preferences as the second user.

Metadata server 116 may provide services to a multitude of user devices, such as user device 201. In one or more implementations, user device 201 may access an API, such as a web-enabled API, provided by metadata server 116 to register with metadata server 116. User device 201 may register by providing metadata server 116 with a device identifier for user device 201 (or user account). User device 201 may then provide user metadata 214 to metadata server 116 to facilitate metadata server 116 with selecting alternative AV streams 208A-C of interest to user device 201 (or user of the device). User metadata 214 may include a marked point-in-time provided in response to a user interacting with user device 201. For example, while viewing a football game, a user may activate a button on a remote control associated with set-top device 110 to mark a current point-in-time. The marked point-in-time may correspond to a particular play of the game that the user wishes to receive more information about (e.g. via alternative AV streams 208A-C). The marked point-in-time may be automatically sent to metadata server 116 and used by metadata server 116 to identify alternative AV streams 208A-C providing information relevant to the marked point-in-time, or an action event associated with the marked point-in-time.

Using the remote control, the user may also enter (via text entry) or select an action event for a current time of live event 130 for which an AV stream is being displayed by user device 201. For example, primary content producer metadata 213 may be provided to set-top device 110 in connection with a display of live event 130 by set-top device 110. Action event-related metadata items may be retrieved by from primary content producer metadata 213 by set-top device 110 in real-time, and representations of the action events may be displayed by set-top device 110 (or output device 114). The user may then select an action event of interest and user metadata 214 that includes a corresponding action event tag and/or a marked point-in-time for the action event is generated and sent to metadata server 116.

In one or more implementations, user metadata 214 may be extracted from a user profile associated with a user of user device 201. Metadata server 116 may store user profile information for each user in data store 118 or other data store. The user profile information may be stored in connection with a user account, such that the information is accessed and updated while the user is authenticated to the user account. For example, user device 201 may include one or more profile screens that allow a user to login to a user account and update a profile, including storing interests of the user. In this manner, the user may store information representative of action events that are of interest to the user, and metadata items may be generated for the stored action events and used by metadata server 116 to select available alternative AV streams 208A-C of interest to the user.

In one or more implementations, the user profile information relevant to alternative AV streams 208A-C may be stored, for example, as an indexed lookup table. Accordingly, when primary content producer metadata 213 is received in connection with primary AV stream 203, one or more action event tags within primary content producer metadata 213 may be used by metadata server 116 to index the lookup table in data store 118 to determine whether the user would be interested in the corresponding action events. In one or more implementations, metadata server 116 may store and update lookup tables in real-time with primary and alternative content producer metadata 213, 212A-C, and then index the lookup tables by user metadata 214 when the user logs into the user account.

As described previously with respect to FIG. 1, metadata server 116 may receive user metadata 214 associated with a user profile in a social networking system 215, or from user activity streams in a social networking system 215. In one or more implementations, metadata server 116 may access or be operably connected to social networking system 215 for retrieving and/or receiving social network user profile information 216. For example, the user may post a message to an activity stream that includes an identifier from which live event 130 can be determined. The identifier may be a hash tag corresponding to live event 130 and/or an action event that has occurred in live event 130. In one or more implementations, a hash tag may be the same identifier as an action event tag prepended with a hash symbol. In one or more implementations, if the user has opted into use of social network information for discovery of alternative AV streams 208A-C, social networking system 215 may be configured to use regular expressions and/or pattern matching to dynamically discover identifiers within messages posted to activity streams or passed between users using an internal mail service of social networking system 215.

In one or more implementations, user metadata 214 is indicative of associations of the one or more users in social networking system 215. For example, a user may have associated themselves with one or more other persons in social networking system 215, such as former sports players, political figures, persons of pop culture interests, or generally any other persons. In one or more implementations, one or more of these persons may be alternative content producers generating one or more of alternative AV streams 208A-C, or associated with one or more of alternative AV stream sources 205A-C. Thus, user metadata 214 may indicate that the user may be interested in alternative AV streams 208A-C generated by alternative content producers that the user associated themselves with in social networking system 215.

On selecting one or more alternative AV streams 208A-C of interest to a user, metadata server 116 may automatically generate one or more representations 217 of selected alternative AV streams 208A-C and provide representations 217 to user device 201 for display (e.g., on output device 114). Representations 217 may each include, for example, one or more still images and/or thumbnail images from one or more corresponding frames of a respective alternative AV stream. Representations 217 may include a thumbnail AV stream that displays the corresponding alternative AV stream in real-time, although in a small frame and in a lower resolution. As shown in FIG. 3 below, representations 217 may be displayed as selectable icons on a display screen associated with user device 201. As available alternative AV streams 208A-C for live event 130 change due to changing primary content producer metadata 213, alternative content producer metadata 212A-C, and/or user metadata 214, representations 217 may dynamically change as well.

In one or more implementations, secondary device 112 may be separate from user device 201 and may be configured to display the previously described social networking system 215. A user account of social networking system 215 may be associated with user device 201 (e.g., set-top device 110) such that user activity within social networking system 215 may contribute to user metadata 214 provided to metadata server 116 and affect which representations 217 are selected and provided to user device 201. A user associated with the user account may then navigate to an event page provided by or associated with social networking system 215 to view representations 217 of alternative AV streams 208A-C for live event 130, for example, displayed at user device 201, or on the event page of social networking system 215 via secondary device 112. On selecting one of the representations 217 of one of alternative AV streams 208A-C, such as alternative AV stream 208A, via social networking system 215, the event page may be provided with alternative AV stream 208A corresponding to selected representation 217, and the user may view alternative AV stream 208A on secondary device 112 via social networking system 215, for example, contemporaneously with a display of primary AV stream 203 by user device 201.

Metadata server 116 may also provide metrics related to live event 130 for a user population viewing live event 130. In this regard, metadata server 116 may coalesce user metadata 214 for a large number of users (e.g., above 100) viewing live event 130 to identify which portions of live event 130 users are most responsive to. In one or more implementations, the coalescing may include identifying popular events, for example action events, that may have transpired during live event 130 or events that would be popular should they occur at a future time. The primary content producer of primary AV stream 203 for live event 130 may use the coalesced user metadata 214 to modify future events, future behavior within live event 130, and/or content of primary AV stream 203 in accord with what is popular and/or to provide more or different content for popular events. For example, in connection with a football game, metadata server 116 may analyze user metadata 214 to determine which plays are most popular. On identifying a popular play, an indication of the play may be sent to the primary content producer for the game, such as via primary CP device 132, and the primary content producer may provide more information about the play via primary AV stream 203 the next time the play is executed. In another example, the primary content producer may communicate, for example via primary CP device 132, a popular play or popular request to players on the field to influence the players in future activities. Accordingly, metadata server 116 may facilitate audience participation in some live events 130.

FIG. 3 illustrates an example user interface 300 for presenting representations of selected AV streams associated with an event in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

Example user interface 300 may include available AV streams menu 330 and main display area 350. In one or more implementations, example user interface 300 may be presented on output device 114, for example, by set-top device 110, on secondary device 112, or generally on any device. Available AV streams menu 330 may include representations 332, 342A-C of available AV streams. Available AV streams menu 330 may include primary AV stream representation 332 in addition to available alternative AV stream representations 342A-C selected by metadata server 116 for the user interacting with example user interface 300. Available AV streams menu 330 may appear in response to a request therefor, for example, by a user interacting with set-top device 110 and/or secondary device 112. Primary AV stream representation 332 may be displayed in available AV streams menu 330 in response to user metadata 214 automatically sent to metadata server 116 when set-top device 110 was activated (e.g., in response to an automatic login to a corresponding user account). In one or more implementations, main display area 350 may be reduced in size to accommodate display of available AV streams menu 330, or main display area 350 may extend behind available AV streams menu 330.

The user may request to view available alternative AV streams 208A-C selected by metadata server 116 for the user during live event 130, for example while viewing primary AV stream 203 for live event 130. The request may be made by the user by interacting with a remote control or keyboard associated with set-top device 110. In one or more implementations, a keyboard or user interface displayed by secondary device 112 may provide the ability to request to view available alternative AV streams 208A-C selected by metadata server 116 for the user. In response to the user request, set-top device 110 may transmit the request to metadata server 116 along with, for example, an identifier of the user and an identifier of live event 130. Metadata server 116 may retrieve user metadata items associated with the user based at least on the user identifier, and metadata items associated with available alternative AV streams 208A-C for live event 130 based at least on the identifier of live event 130.

Metadata server 116 may select available alternative AV streams 208A-C that may be of interest to the user based at least on alternative content producer metadata 212A-C received for available alternative AV streams 208A-C and user metadata 214. Metadata server 116 may provide representations 342A-C of selected alternative AV streams 208A-C to set-top device 110. Representations 332, 342A-C may display previews, for example, still frames or video streams, of selected alternative AV streams 208A-C. As shown in FIG. 3, representation 342B of alternative AV stream 208B includes overlay 344 and representation 342C of alternative AV stream 208C includes supplemental content 346, such as a supplemental video stream. Representations 332, 342A-C may also include an identifier, such as a name, of the alternative content producer that generated/produced the corresponding alternative AV streams 208A-C.

The user may select one of representations 332, 342A-C, such as representation 342A of alternative AV stream 208A selected by metadata server 116 for the user. Set-top device 110 may transmit an indication of the selection to metadata server 116 and/or AV content server 120. In one or more implementations, metadata server 116 may provide set-top device 110 with an identifier for accessing selected alternative AV stream 208A from AV content server 120 or from a network location, for example, by providing set-top device 110 with a network address (e.g., URL) for locating a server configured to provide selected alternative AV stream 208A. On receiving selected alternative AV stream 208A, set-top device 110 presents alternative AV stream 208A to the user, for example, on output device 114.

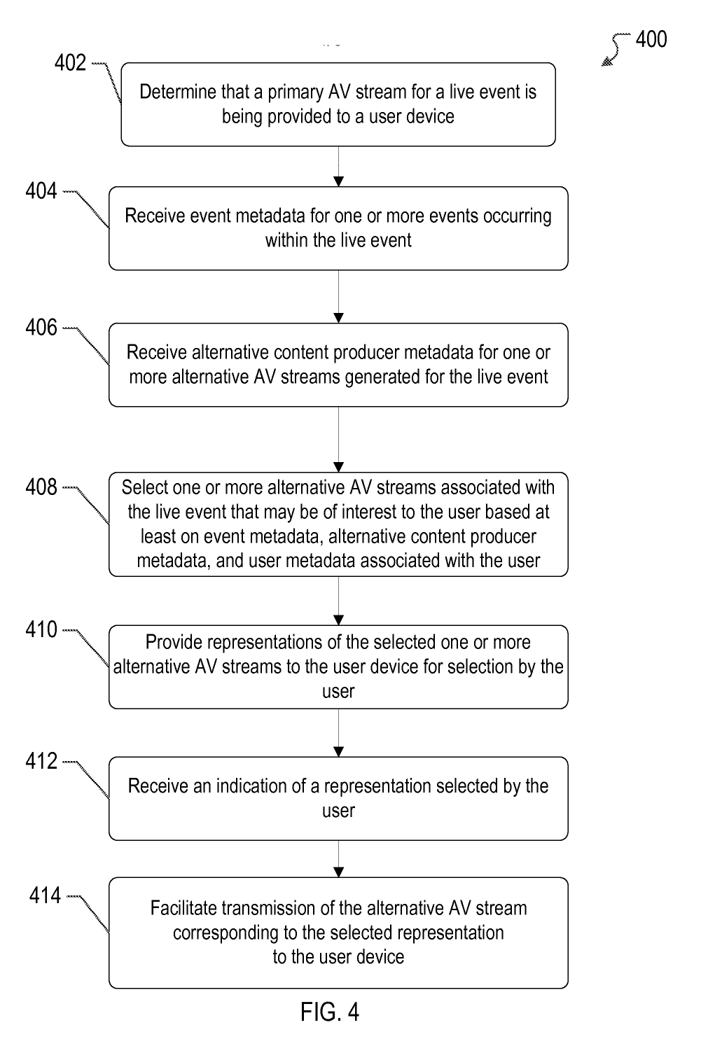

FIG. 4 illustrates a flow diagram of an example process 400 for selecting AV streams associated with an event in accordance with one or more implementations. For explanatory purposes, example process 400 is primarily described herein with reference to metadata server 116 of FIG. 1; however, example process 400 is not limited to metadata server 116 of FIG. 1, and example process 400 may be performed by one or more components of metadata server 116, or a different server of example network environment 100. Further for explanatory purposes, the blocks of example process 400 are described herein as occurring in serial, or linearly. However, multiple blocks of example process 400 may occur in parallel. In addition, the blocks of example process 400 need not be performed in the order shown and/or one or more of the blocks of example process 400 need not be performed.

Metadata server 116 determines that primary AV stream 203 is being provided to user device 201 for live event 130 (402). For example, user device 201 may transmit an indication to metadata server 116 that indicates that primary AV stream 203 is being presented to a user via user device 201, along with an identifier of the user and/or user metadata 214 that is indicative of attributes and/or preferences of the user. Metadata server 116 may receive primary content producer metadata 213 that includes event metadata for one or more events, such as action events, occurring during live event 130 (404). In one or more implementations, metadata server 116 may receive primary content producer metadata 213 contemporaneous with the occurrence of each action event within live event 130. For example, in a football game the action event may be a play on the field (e.g., a pass to a receiver). In a movie, the action event may be a scene in which some distinctive incident takes place (e.g., a building explodes). In one or more implementations, primary content producer metadata 213 may include metadata indicative of user devices 201 to which primary AV stream 203 is being provided.

In one or more implementations, metadata server 116 may also receive alternative content producer metadata 212A-C that is indicative of characteristics of the alternative content producers generating available alternative AV streams 208A-C (406). Metadata server 116 selects one or more alternative AV streams 208A-C associated with live event 130 that may be of interest to the user based at least on primary content producer metadata 213, user metadata 214, and/or alternative content producer metadata 212A-C (408).

Metadata server 116 provides representations 342A-C of one or more selected alternative AV streams 208A-C for live event 130 to user device 201 for selection by the user in connection with display of primary AV stream 203 for live event 130 (410). As described with respect to FIG. 3, representations 342A-C may be presented in available AV streams menu 330 that is activated when a user requests to view available alternative AV streams 208A-C, or when a user selects to activate available AV streams menu 330. In one or more implementations, user device 201 may be operably connected to social networking system 215, and a user interface provided by social networking system 215 may be used to view representations 342A-C. For example, the user may navigate, within social networking system 215, to an event page related to live event 130. Social networking system 215 may receive primary AV stream 203 for display on the event page. In one or more implementations, the event page may also display representations 342A-C of available alternative AV streams 208A-C selected for the user who is authenticated with social networking system 215.

Metadata server 116 receives an indication of selected representation 342A from user device 201, social networking system 215, or secondary device 112 associated with the user (412). As described previously, user device 201 may be implemented as set-top device 110 operably connected to output device 114. In one or more implementations, secondary device 112 may be, for example, a mobile device or other computing device associated with the user that displays pages of social networking system 215 or that displays an activity stream of social networking system 215.

Once the user selects one of representations 342A-C, such as representation 342A, metadata server 116 facilitates transmission of selected alternative AV stream 208A corresponding to selected representation 342A to user device 201 (414). Accordingly, metadata server 116 may provide user device 201 with an identifier for accessing selected alternative AV stream 208A from a network location, for example, by providing user device 201 with a network address (e.g., URL) for locating a server configured to provide selected alternative AV stream 208A. On receiving selected alternative AV stream 208A, user device 201 presents selected alternative AV stream 208A to the user, for example, on output device 114.

FIG. 5 conceptually illustrates an electronic system 500 with which one or more implementations of the subject technology may be implemented. Electronic system 500, for example, can be a gateway device, a set-top device, a desktop computer, a laptop computer, a tablet computer, a server, a switch, a router, a base station, a receiver, a phone, a personal digital assistant (PDA), or generally any electronic device that transmits signals over a network. Such an electronic system includes various types of computer readable media and interfaces for various other types of computer readable media. Electronic system 500 includes bus 508, one or more processor(s) 512, system memory 504 or buffer, read-only memory (ROM) 510, permanent storage device 502, input device interface 514, output device interface 506, and one or more network interface(s) 516, or subsets and variations thereof.

Bus 508 collectively represents all system, peripheral, and chipset buses that communicatively connect the numerous internal devices of electronic system 500. In one or more implementations, bus 508 communicatively connects one or more processor(s) 512 with ROM 510, system memory 504, and permanent storage device 502. From these various memory units, one or more processor(s) 512 retrieve instructions to execute and data to process in order to execute the processes of the subject disclosure. One or more processor(s) 512 can be a single processor or a multi-core processor in different implementations.

ROM 510 stores static data and instructions that may be needed by one or more processor(s) 512 and other modules of electronic system 500. Permanent storage device 502, on the other hand, may be a read-and-write memory device. Permanent storage device 502 may be a non-volatile memory unit that stores instructions and data even when electronic system 500 is off. In one or more implementations, a mass-storage device (such as a magnetic or optical disk and its corresponding disk drive) may be used as permanent storage device 502.

In one or more implementations, a removable storage device (such as a floppy disk, flash drive, and its corresponding disk drive) may be used as permanent storage device 502. Like permanent storage device 502, system memory 504 may be a read-and-write memory device. However, unlike permanent storage device 502, system memory 504 may be a volatile read-and-write memory, such as random access memory. System memory 504 may store any of the instructions and data that one or more processor(s) 512 may need at runtime. In one or more implementations, the processes of the subject disclosure are stored in system memory 504, permanent storage device 502, and/or ROM 510. From these various memory units, one or more processor(s) 512 retrieve instructions to execute and data to process in order to execute the processes of one or more implementations.

Bus 508 also connects to input and output device interfaces 514 and 506. Input device interface 514 enables a user to communicate information and select commands to electronic system 500. Input devices that may be used with input device interface 514 may include, for example, alphanumeric keyboards and pointing devices (also called “cursor control devices”). Output device interface 506 may enable, for example, the display of images generated by electronic system 500. Output devices that may be used with output device interface 506 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

As shown in FIG. 5, bus 508 also couples electronic system 500 to one or more networks (not shown) through one or more network interface(s) 516. One or more network interface(s) may include an Ethernet interface, a Wi-Fi interface, a multimedia over coax alliance (MoCA) interface, a reduced gigabit media independent interface (RGMII), or generally any interface for connecting to a network. In this manner, electronic system 500 can be a part of one or more networks of computers (such as a local area network (“LAN”), a wide area network (“WAN”), or an Intranet, or a network of networks, such as the Internet. Any or all components of electronic system 500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, for example, via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method for selecting audio-video (AV) streams generated for a live event, comprising:
determining that a primary AV stream for a live event is being provided to a device associated with a user;
receiving event metadata associated with an action event occurring within the live event;
selecting one or more alternative AV streams associated with the live event based at least on the event metadata and user metadata associated with the user; and
providing one or more representations of the one or more alternative AV streams to the device associated with the user for selection by the user.

2. The method of claim 1, wherein the one or more alternative AV streams are produced by one or more alternative content producers, and selecting the one or more alternative AV streams associated with the live event based at least on the event metadata and the user metadata further comprises:
selecting the one or more alternative AV streams associated with the live event based at least on the event metadata, the user metadata, and alternative content producer metadata associated with the one or more alternative content producers.

3. The method of claim 2, further comprising:
retrieving the user metadata from a social networking system, the user metadata being indicative of an association of the user in the social networking system with at least one of the one or more alternative content producers.

4. The method of claim 3, wherein providing the one or more representations of the one or more alternative AV streams to the device associated with the user for selection by the user further comprises:
providing the one or more representations of the one or more alternative AV streams to the device associated with the user for selection by the user via a user interface associated with the social networking system.

5. The method of claim 4, further comprising:
receiving an indication of selection by the user of one of the one or more alternative AV streams via the user interface associated with the social networking system; and
facilitating transmission of the one of the one or more alternative AV streams selected by the user to the device associated with the user for display via the user interface associated with the social networking system.

6. The method of claim 2, wherein the alternative content producer metadata for one of the selected one or more alternative AV streams comprises a characteristic of the one of the one or more alternative content producers that generated the one of the selected one or more alternative AV streams, the user metadata is indicative of a preference of the user for the characteristic or for the one of the one or more alternative content producers, and the action event associated with the event metadata is related to the characteristic.

7. The method of claim 6, wherein the live event comprises a sporting event, the action event comprises a play within the sporting event, and the characteristic is indicative of an expertise of the one of the one or more alternative content producers with respect to the play.

8. The method of claim 1, wherein the event metadata is received contemporaneously with an occurrence of the action event within the live event.

9. The method of claim 1, further comprising:
providing the one or more representations of the one or more alternative AV streams to a secondary device associated with the user for selection by the user.

10. The method of claim 9, further comprising:
receiving an indication of selection by the user of one of the one or more alternative AV streams associated with the live event from the secondary device associated with the user; and
facilitating transmission of the one of the one or more alternative AV streams selected by the user to the device associated with the user.

11. The method of claim 1, further comprising:
receiving additional user metadata associated with a plurality of users viewing the primary AV stream or one of the one more alternative AV streams for the live event;
coalescing the user metadata and the additional metadata;
identifying, based at least on the coalesced user metadata and the additional metadata, one or more popular action events that occurred within the live event; and
providing an indication of the one or more popular action events to a primary AV content producer that generated the primary AV stream.

12. A computer program product comprising instructions stored in a tangible computer-readable storage medium, the instructions comprising:
instructions for receiving an indication that a primary audio-video (AV) stream for an event is being provided to a device associated with a user, the primary AV stream being generated by a primary content producer;
instructions for receiving alternative content producer metadata that is indicative of characteristics of a plurality of alternative content producers, each of the plurality of alternative content producers generating one of a plurality of alternative AV streams for the event;
instructions for receiving user metadata associated with the user, the user metadata being indicative of attributes of the user;
instructions for selecting one or more of the plurality of AV streams for the event based at least on the characteristics of the plurality of alternative content producers indicated by the alternative content producer metadata and the attributes of the user indicated by the user metadata; and
instructions for providing representations of the one or more alternative AV streams to the device associated with the user for selection by the user in connection with a display of the primary AV stream.

13. The computer program product of claim 12, wherein the instructions for receiving the user metadata associated with the user further comprise:
instructions for receiving the user metadata associated with the user from the device associated with the user, the user metadata being indicative of AV streams viewed by the user via the device.

14. The computer program product of claim 12, further comprising:
instructions for receiving an indication of a selected representation from the device associated with the user or from a secondary device associated with the user; and
instructions for facilitating transmission of one of the plurality of alternative AV streams corresponding to the selected representation to the device or the secondary device.

15. The computer program product of claim 12, wherein the instructions for receiving the user metadata associated with the user further comprises:
instructions for retrieving the user metadata associated with the user from a social networking system, the attributes of the user comprising associations of the user in the social network, at least one of the associations being with one of the plurality of alternative content producers.

16. The computer program product of claim 15, further comprising:
instructions for identifying one or more indications of the event within one or more messages generated by the user in the social networking system; and
instructions for retrieving the user metadata from the social networking system based at least in part on the identified one or more indications of the event within the one or more messages.

17. A system, comprising:
one or more computing devices; and
a memory including instructions that, when executed by the one or more computing devices, cause the one or more computing devices to:
identify a primary audio-video (AV) stream for a live event being transmitted to a user device, the primary AV stream being generated by a primary AV stream source;
receive, from the primary AV stream source, event metadata for one or more events occurring within the live event;
identify one or more alternative AV streams associated with the live event based at least on the event metadata and user metadata associated with one or more users; and
provide representations of the one or more alternative AV streams for selection at the user device in connection with the user device receiving the primary AV stream.

18. The system of claim 17, wherein the event metadata is received contemporaneously with an occurrence of each of the one or more events within the live event.

19. The system of claim 18, wherein the instructions, when executed by the one or more computing devices, cause the one or more computing devices to:
receive, from the user device, an indication that a user marked one of the one or more events occurring within the live event;
receive alternative source metadata from a plurality of alternative AV stream sources that generate a plurality of alternative AV streams, the plurality of alternative AV streams including the one or more alternative AV streams; and
identify the one or more alternative AV streams based at least in part on comparing the marked one of the one or more events with the alternative source metadata.

20. The system of claim 17, wherein the instructions, when executed by the one or more computing devices, cause the one or more computing devices to:
receive an indication of a selected one of the representations from the user device or from a secondary user device that is located proximally to the user device; and
facilitate providing the one of the one or more alternative AV streams corresponding to the selected one of the representations to the user device.
